(19) United States
(12) Patent Application Publication
(10) Pub. No.: US 2013/0290693 A1
(43) Pub. Date: Oct. 31, 2013

(54) Method and Apparatus for the Automatic Generation of RTL from an Untimed C or C++ Description as a Fine-Grained Specialization of a Micro-processor Soft Core

(71) Applicants: Miguel A. Guerrero, San Jose, CA (US); Alpesh B. Oza, San Jose, CA (US)

(72) Inventors: Miguel A. Guerrero, San Jose, CA (US); Alpesh B. Oza, San Jose, CA (US)

(73) Assignee: ESENCIA TECHNOLOGIES INC., San Jose, CA (US)

(21) Appl. No.: 13/891,909

(22) Filed: May 10, 2013

Related U.S. Application Data
(63) Continuation-in-part of application No. 13/872,414, filed on Apr. 29, 2013.
(60) Provisional application No. 61/645,340, filed on May 10, 2012.
(60) Provisional application No. 61/639,282, filed on Apr. 27, 2012.

(51) Int. Cl. G06F 9/445

(52) U.S. Cl. CPC G06F 9/44505
USPC 713/1

(57) ABSTRACT

A system and method for configuring a configuring a register transfer level description from a programming language may utilize a configurable microprocessor core. A compiler may compile the programming language using performance statistics and user constraints. A template processor may translate the programming language into register transfer level description language using template files. Timing and area constraints may be used prior to output a gate level netlist ready to place on a microchip.

### CROSS-REFERENCE TO RELATED APPLICATIONS

This Application claims the benefit of Provisional Application Ser. No. 61/645,340, filed May 10, 2012 and Non-Provisional application Ser. No. 13/872,414, filed Apr. 29, 2013 which claimed the benefit of Provisional Patent Application No. 61/639,282 filed Apr. 27, 2013.

### BACKGROUND OF THE INVENTION

Microprocessor cores are components of microprocessor units that may read and execute program instructions to perform specific tasks. Conversion of C or C++ to RTL (Register Transfer Level description) may be desirable to integrate systems. Configurability may add value to the microprocessor core by allowing a user to choose the best performance/area trade-offs that meet the requirements of the typical applications to run.

As can be seen, there is a need for a method and apparatus fur the automatic generation of RTL from C or C++.

### SUMMARY

In one aspect of the invention, a system for configuring a register transfer level description comprises a configurable microprocessor core; a compiler stored on a development computer system intended to compile an input program expressed on an input high-level programming language; a register transfer level description template processor stored on the development computer system and configured to translate the programming language into the register transfer level description using a plurality of register transfer level templates; and a hardware description language synthesizer stored on the development computer system, wherein the system is generated from a human written template with multiple parameters that are configured semi-automatically or with user control, wherein the system is configured to receive a programming language and output a register transfer level description, wherein the system utilizes data sets with performance statistics, wherein the system utilizes template files that include the register transfer level templates, and wherein the system utilizes timing and area constraints.

In another aspect of the invention, A system for configuring a register transfer level description comprises a one-time configurable, non-reprogrammable microprocessor core; a compiler stored on a development computer system and configured to compile an input program on expressed on a high-level input programming language; a register transfer level description template processor stored on the development computer system and configured to translate the programming language into the register transfer level description using a plurality of register transfer level templates; and a hardware description language synthesizer stored on the development computer system, wherein the register transfer description is generated from a human written template with multiple parameters that are configured semi-automatically or with user control, wherein the system is configured to receive a programming language and output a register transfer level description, wherein the system utilizes data sets with performance statistics, wherein the system utilizes user constraints, wherein the system utilizes template files that include the register transfer level templates, wherein the system utilizes timing and area constraints, and wherein the following are “definition time” configurable: presence or absence of an interrupt controller on the microprocessor core; whether the microprocessor core has a big-endian or little-endian configuration; width of a data path in the microprocessor core; whether a plurality of restricted predication instructions are included in a plurality of slots of the microprocessor core; whether the microprocessor core has a top down and application driven configuration; whether binary translation post processing into an instruction set architecture from a different processor instruction set architecture is performed; whether the compiler automatically detects a combination of instructions; whether a human-written template description written in hardware description language may be utilized for description of the microprocessor core; whether user defined extension instructions are provided in different languages as different views of the extension instructions, and are provided as an interface to other instructions; whether instruction encoding for one of the slots in the microprocessor core includes a set of supported instructions and a number of registers supported for the one of the slots; whether a plurality of vector processing units is included; whether a plurality of floating point units with configurable precision is included and whether data is statistically spread across multiple banks of memory in the microprocessor core.

In a further aspect of the invention, a system for configuring register transfer values comprises a value constraint block, including a value limiter configured to determine the relevance of register transfer values on a bus; a decoder configured to decompose one of the register transfer values on the bus into a vector; and a value stopper configured to allow only relevant ones of the register transfer values on the bus to proceed; and an encoder configured to re-encode the register transfer values on the bus using the relevant register transfer values on the bus.

These and other features, aspects and advantages of the present invention will become better understood with reference to the following drawings, description and claims.

### BRIEF DESCRIPTION OF THE DRAWINGS

FIG. 1 illustrates a block diagram showing configurable hardware in an exemplary embodiment of the present invention;

FIG. 2 illustrates a block diagram of the configurable hardware of FIG. 1 showing interfacing with a bus, program and data memories and optional peripherals;

FIG. 3 illustrates a high-level view of a multi-core subsystem of FIG. 1;

FIG. 4 illustrates a screen view of a user interface for the configurable hardware of FIG. 1;

FIG. 5 illustrates a flow chart of software configuration in another exemplary embodiment of the invention;

FIG. 6 shows a flow chart of C to RTL flow; and

FIG. 7 shows a block diagram showing an example value constraint block.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a framework for the conversion of C or C++ to RTL.

The invention may allow entry of C/C++ code for the generation of RTL. Multiple parameters may be entered into a configurable microprocessor core, hereinafter referred to as an EScala-CtoRTL core. The configurable microprocessor core may also be referred to as Escala, but for the purposes of this application, will be referred to as an EScala-CtoRTL core. Constraint blocks may also be added to increase efficiency of RTL generation.

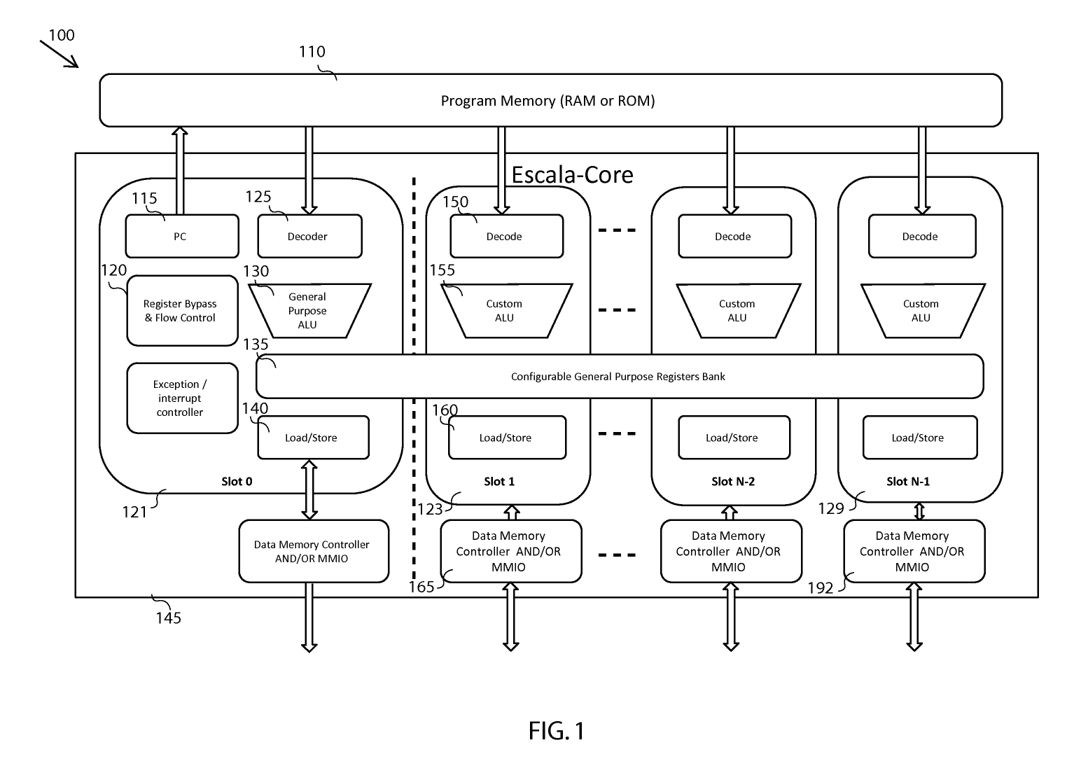

Referring to FIG. 1, a block diagram of the present invention 100 showing configurable hardware is shown. Program memory 110 instruction fetching may be driven by a program counter (PC) 115 and may share data with a decoder 125.

A Bus Multiplexer (BUSMUX) and register bypass with flow control 120 may feature register-bypass/forwarding across slots. EScala-CtoRTL generated processor instances may be fully pipelined and may feature register-bypass/forwarding across slots. This feature may allow an instruction in a cycle n to use the results produced in a cycle n-1 even though those results are not yet written back into the register file. An instruction in cycle n may need to consume data from an instruction in cycle n-1 and may be forced to be in a different slot due to slot specialization. The register bypass across slots may avoid unnecessary delays in the processing chain. The number of registers in a register file/set may be configurable and may be virtually limitless. Solutions may range from very few registers to hundreds of them to avoid excessive memory accesses during performance intensive loops.

EScala-CtoRTL cores are statically scheduled microprocessors, such that the compiler decides at compilation time which slots execute which instructions, with a plurality of slots, the number of slots being fully configurable. Each slot may comprise an independent data-path including its own instruction decoding and execution units (e.g., Arithmetic Logic Units or ALU's) independent of the other slots. One of the slots may be specialized for jump instructions and thus only one (common) copy of the program counter may be kept for the whole processor. EScala-CtoRTL may include Harvard architecture processors, where instruction and data space are separate. This may allow for increased execution throughput on cache-less systems.

The program memory 110 also may share data with a decoder associated with a plurality of “Slots” (datapaths configurated for a microprocessor core), from Slot 0 123 to Slot N-1. Each slot, such as slot 1 123, may comprise, in addition to a decoder 150, a custom arithmetic logic unit (ALU) 155 and a load/store unit 160. EScala-CtoRTL may include a configurable number of load/store units ranging from 1 to the number of slots instantiated on a given configuration/instantiation of a microprocessor core. Local memory to the microprocessor may be banked in such a way that the number of banks is decoupled from the number of load/store units. An application may use a number of banks at least equal or greater than the number of load/store units to get a performance advantage.

A data memory controller 145 may output the data to a bus or, for example, a computer monitor. A configurable general purpose register(s) bank 135 may communicate with both the PC 115 and all slots from slot 0 123 through slot N-1 129. The mapping of data into banks may be performed in several ways. Under detailed user control, in which the user may specify which program ‘section’ a data-structure belongs to by inserting appropriate ‘pragma’ or compiler directive information in the source code or alternatively in a plurality of separate control files. Subsequent steps during program linking may map those sections into specific memory banks according the user inputs. Alternatively data may be statistically spread, either automatically or by a user, across multiple banks of memory (e.g., every bit word may be assigned to a bank in sequentially increasing order, wrapping around to the bank once the highest bank is reached). This may be effective when the user has little knowledge on which data structures are used simultaneously during the program.

Each slot from slot 0 123 through slot N-1 129 may interact with a configurable memory-mapped input/output (MMI 0) unit 165,192. Slot 0 121 may include a general purpose arithmetic logic unit 130, and may interact with a data memory controller 145 through a load/store unit 140. EScala-CtoRTL may support high bandwidth (BW) paths to other peripheral or to other EScala-CtoRTL instantiations. These paths may be separate from load/store paths to memory. Communication through these channels may follow a simple first-in first- out (FIFO) like interface and allows the program being executed to be automatically flow-controlled (data-flow architecture) if the requested data is not available or the produced data has not been consumed by a downstream device. This may allow EScala-CtoRTL to generate processor instances to follow a simple programming model where there is no need for the controlling software to check levels of data available/consumed. This may allow the efficient implementation of multi-core microprocessor subsystems with sophisticated high-performance inter core connectivity patterns.

EScala-CtoRTL may allow a microprocessor core to be configured by a user or by an application program. Examples of configurable items in the microprocessor core may be memory, decoder units, arithmetic logic units, register banks, storage units, register bypass units, number of timers, and user interfaces. The storage units may have load and/or store capabilities.

EScala-CtoRTL may be configured in other features as well:
Presence or absence of exception/interrupt controller where individual exceptions can be configured to be supported or not.
Presence or absence of instruction and/or data caches along with their sizes and associativity characteristics (direct mapped, multi-way) and for data-caches whether is write-through or write-back.
Presence or absence of one or more floating point arithmetic acceleration units on a per slot basis with granularity on types of operations and precision supported by the hardware (reduced precision, single precision, double precision or user defined).
Presence or absence of one or more vector processing units on a per slot basis with defining parameters such as number of items per vector, vector element bit width, vector operations supported and vector memory bus width configurable separately on a per instance/slot basis.
The number of vector registers supported in the vector register file.
The presence or absence of hardware support for unaligned data memory accesses.
Whether all the registers are accessible to all slots or they are ‘clustered’, for example, different subsets of registers accessible by different subsets of slots (with or without overlap).
Whether restricted predication instructions are to be included or not (on a per slot basis).
Whether vector memory (for processors featuring a vector unit) is shared with non-vector data or not.
Whether an instruction compression unit should be included or not.
Whether the processor core behaves as big-endian or little-endian.
The number of pipeline stages (among a limited set of options).
Whether the data path should be reduced from the nominal 32b to 16b or expanded to 64b for area reductions of performance increases respectively.

The configuration choices described above provide the user with the capability of trading off area/performance/power as it best fits the application(s) at hand providing a wide range of EScala-CtoRTL options.

Additionally a set of EScala-CtoRTL generated files intended for software consumption (software development kit or SDK) for a given configuration may include a set of C++ classes or C API to handle vectors in a unified fashion so that depending on the HW implementation it takes advantage of extra vector processing unit operations or processes data without hardware vector processing unit support. Similarly it contains configuration/option information to inform the compiler on whether some specific operations need to be emulated or have native hardware support. This may allow EScala-CtoRTL configuration exploration graphical user interface (GUI) to generate configurations with a wide range of performance area power trade-offs without requiring the user to modify its source code in most cases.

An EScala-CtoRTL hardware description may be generated from a hand-written template-based description. This approach may be more reliable and efficient than full dynamic code generation. The template description may be personalized with EScala-CtoRTL generated parameter files to produce a complete and self contained hardware description language (HDL) description of the microprocessor. Microprocessor core generation may be based on a semi-automated configuration (including tool driven configuration and user provided inputs) of a parametric, human-written templates of HDL code for the hardware description of the microprocessor core.

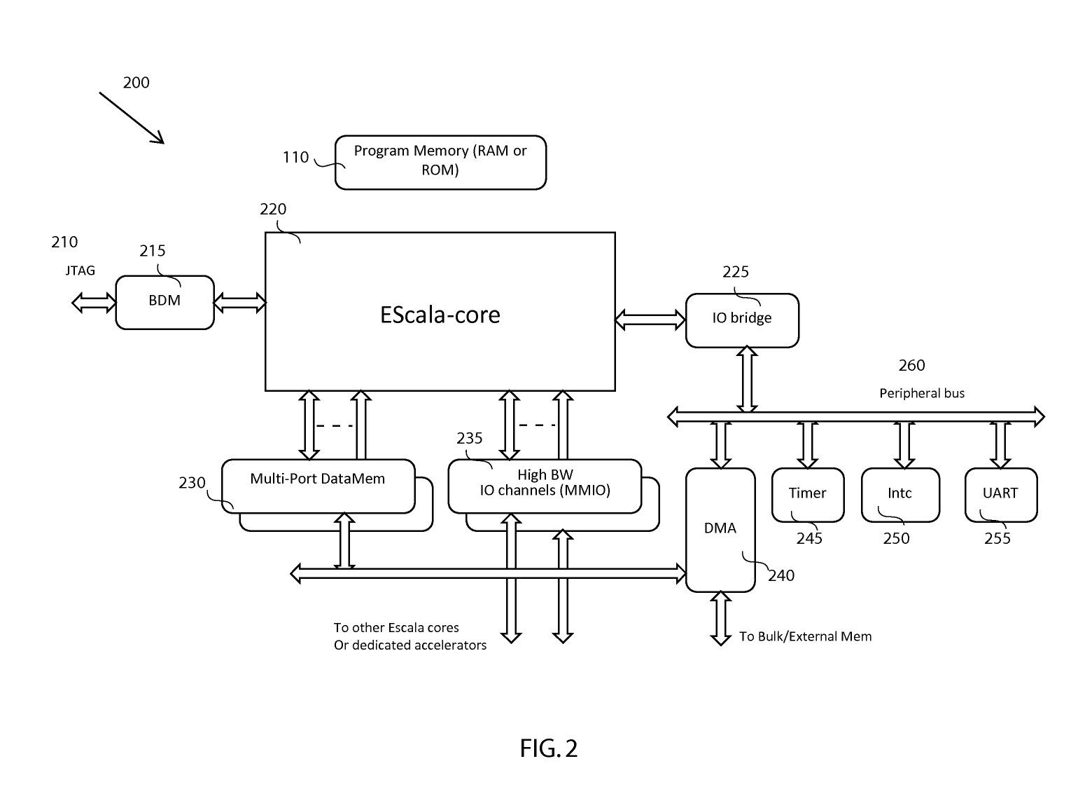

FIG. 2 illustrates a block diagram 200 of the configurable hardware of FIG. 1 showing interfacing with a bus 260. An EScala-CtoRTL configurable microprocessor core 220 is shown interfacing with memory 110 (which for EScala-CtoRTL is ROM) , BDM (background debug module) connected with JTAG (joint test action group) interface, an IO bridge 225, high bandwidth IO channels 235, and multi-port data memory 230. The peripheral bus 260 is shown connected with direct memory access (DMA) 240, a timer 245, interrupt controller (Intc) 250, and a universal asynchronous receiver/transmitter (UART) 255.

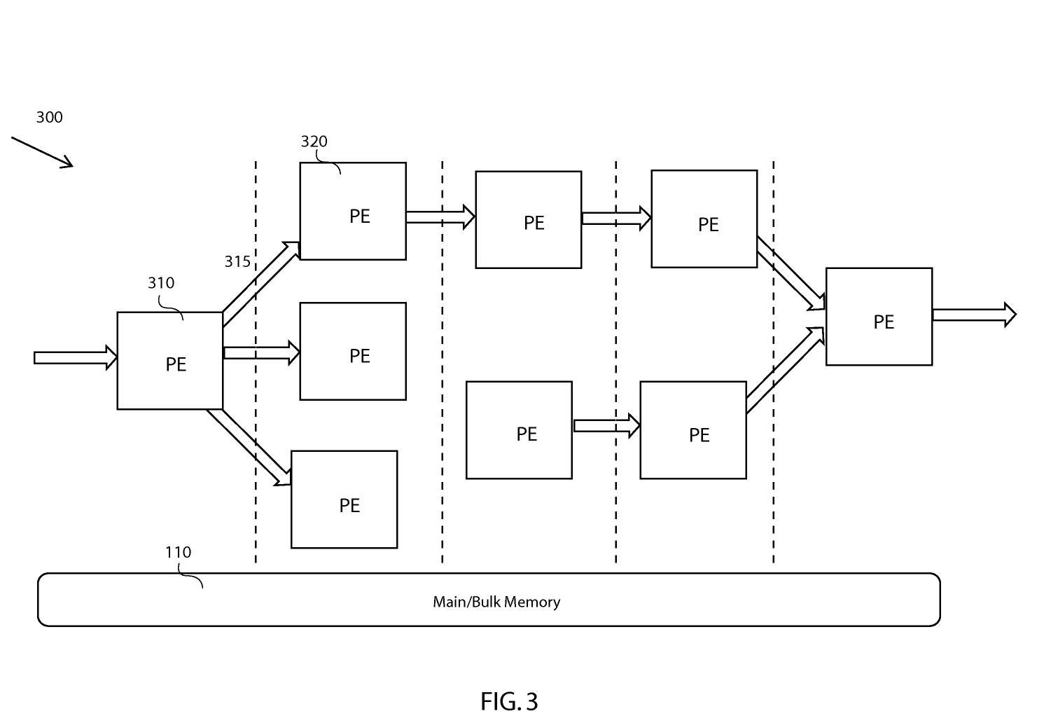

FIG. 3 illustrates a high-level view 300 of a multi-core subsystem of FIG. 1. Shown are multiple microprocessor cores 310, 320, with an interface 315 between the microprocessor cores. All microprocessor cores (PE) may access main bulk memory 110. Creation of multi-processor systems may exploit task level parallelism.

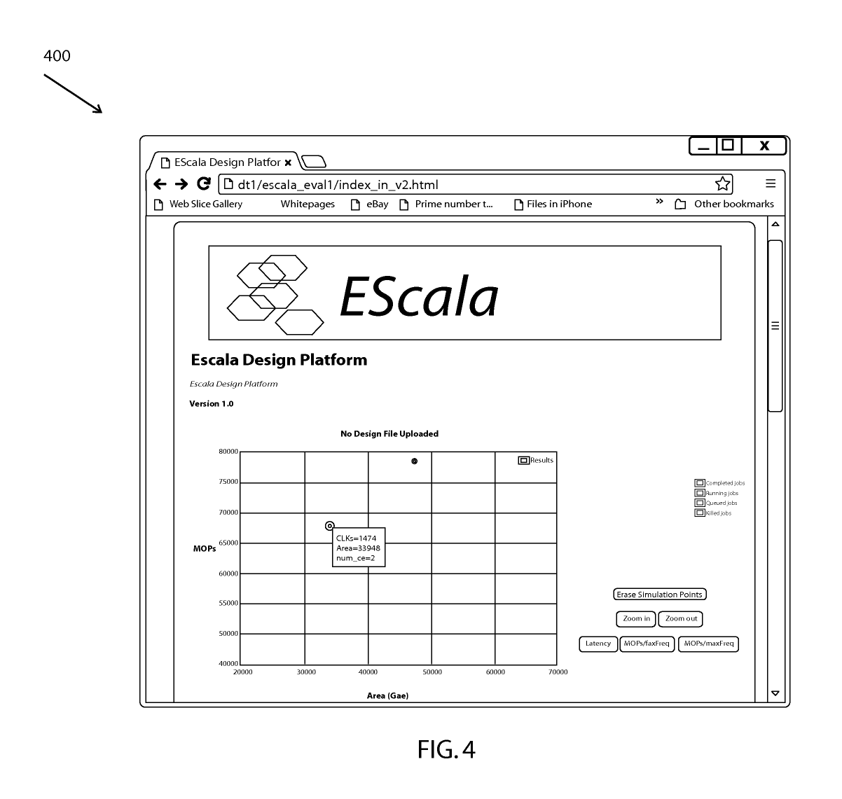

FIG. 4 illustrates a screen view 400 of a user interface for the configurable hardware of FIG. 1. In an exemplary embodiment, a user interface design may be chosen based on an array of automatically generated options. A web interface may run applications on a cloud. A customer may dedicate virtual machines on the web to configure microprocessor cores. A user interface may also be installed on a fixed local computer for microprocessor core design.

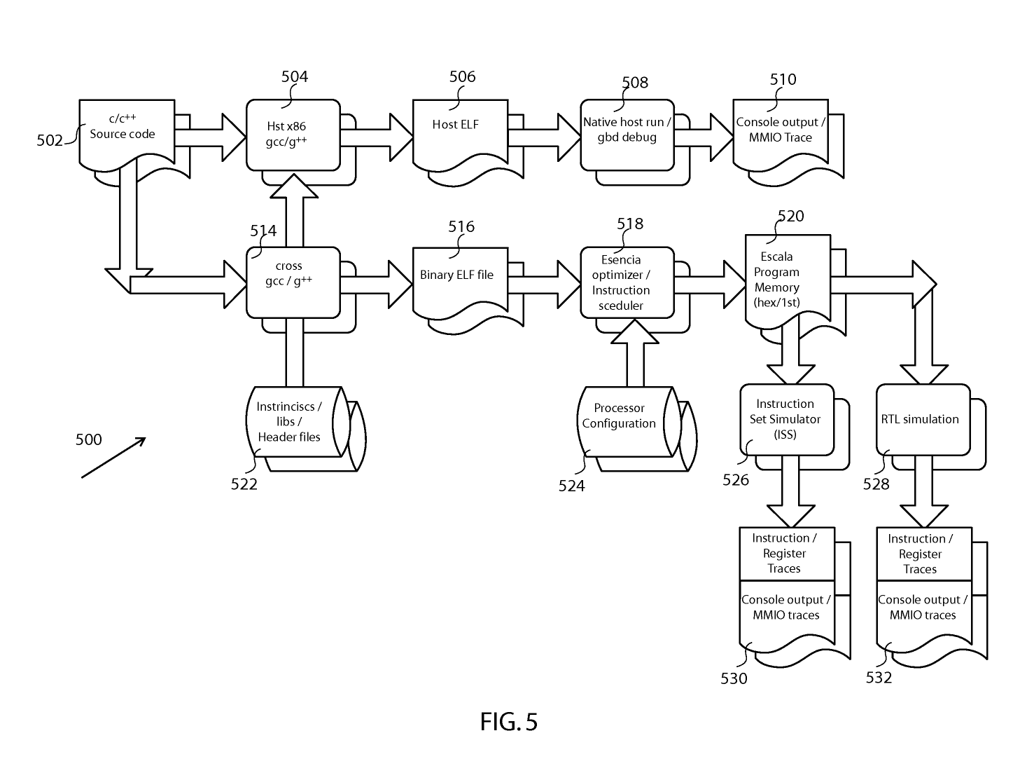

Referring to FIG. 5, a flowchart of configuration of software according to an embodiment of the invention 500 is shown. Source code 502 such as C/C++ may be fed into a cross compiler 514, into an Executable and Linkeable Format (ELF) host file 506, through a native host run/gdb debugger 508, and out to a console 510, with a user interface that may show MMIO traces. For example, a configuration for a microprocessor may be received, and may be combined with an instruction set. This instruction set may then be fed into a simulator to analyze performance of the instruction set on the simulator. Instructions may then be added or deleted from the instruction set based on performance of the instructions on the microprocessor using the simulator. Performance of each of the instructions in the instruction set may be output in the form of a graph on a user interface. The instruction set may be customized based on current performance of the instruction set. In addition, the instruction set may be customized based on individual slot properties for each slot on the microprocessor.

Configuration of software 500 may also be performed using a preprocessor, before feeding code into an EScala-CtoRTL cross-compiler 514 such as gcc/g++. Header files /libraries/Instrinsics may be fed into the cross compiler 514. A binary ELF file 516 may result that can be used to generate program memory ROM contents. EScala-CtoRTL software flow also allow the cross-compiler to be a non-native EScala-CtoRTL cross-compiler by performing binary translation post processing into EScala-CtoRTL instruction set architecture (ISA) from a different processor instruction set architecture.

An optimizer/instruction scheduler 518 such as EScala-CtoRTL compiler may be fed a processor configuration 524, and the instruction scheduler 518 may be used to feed instructions into program memory 520, after which a register transfer level (RTL) simulation may be performed. Instruction/register traces and console output/MMI 0 traces may be output to a console 532 for comparison with the traces generated by instruction set simulations and native host simulations.

Instructions may also be fed to an instruction set simulator (ISS) 526, from which instruction/register traces and console/output MMI 0 traces 530 may be output to a console. Configuration files may be frozen when RTL files for hardware generation are integrated into a silicon design. The customized program along with the configuration files may be fed to the instruction set simulator 526 to make sure that functionality matches what is expected (captured by traces on native host simulations), to evaluate cycle count/performance and to ensure that the RTL files generated are also functioning and performing correctly.

A base Instruction Set Architecture (ISA) may be reduced if specific portions of the ISA are not used under automated analysis of the application to achieve area efficiencies typical of RTL fixed function implementations. This is performed at a very low level of granularity for fixed function devices where the functionality or program to be executed by the microprocessor core is fixed.

The base ISA may be expanded in various ways: The user may provide a set of “user defined extension instructions”. These user defined extension instructions may become part of the microprocessor core by providing a standard interface to any number of such a user defined extension instructions. The presence of the extension instructions may be controlled on a per-slot basis. The presence of the extension instructions may increase a number of input/output operands by “ganging” or combining slots in the microprocessor core. The user may provide several views of the extension instruction (functional C/C++ for simulation, RTL for generation) which may be automatically checked for equivalence. This approach provides full flexibility to the user. Alternatively the descriptions may be derived from a common representation (for example but not limited to the RTL version of it, where the simulation view is automatically generated from it with standard simulation flows). Additionally, EScala-CtoRTL framework may automatically detect new instructions that may benefit an overall cost function (typically a function including program performance and overall area/power cost) by combining several instructions that repeat in sequence in performance of critical portions of the program. The application statistics taken by EScala-CtoRTL may allow the toolset to decide which instructions are more interesting to be generated. This ‘combo’ instruction derivation may be automatically performed by a compiler and may be performance-driven but may also be area driven (to economize in register utilization) under user control.

Extension instructions may be instantiated in the program or discovered by the EScala-CtoRTL frame work in the following ways: Instantiation may happen in the way of ‘instrinsics’ or function calls that directly represent low level extension instructions. Additionally, an EScala-CtoRTL framework tool chain may automatically discover graph patterns that match these instructions in the low level representations of the program. Furthermore, C++ operator overloading may be used to map into the extension instructions during program compilation.

Extension instructions may be combined to allow for extra input/output operands. For example, an extension instruction may be defined as occupying two slots. This allows the extension instruction hardware to write to two destination registers and source two times the amount of input operands (or alternatively the same number of input operands two times as wide) without any extra added complexity to the rest of the microprocessor Hardware. The number of slots need not be limited to two. In general, an extension instruction utilizing N slots may receive 2×N operands and generate N outputs, or receive 2 operands N times as wide as the original ones and produce one result N times as wide as the originals or combinations in between.

The instruction encoding may be parameterized and configured automatically to be the most efficient fit for the final ISA selected (base ISA with possible reductions plus possible extensions). The instruction encoding may also be customized per slot to allow for efficient slot specialization. For example if a slot performs only loads or no-operations (NOPs), a single bit may be sufficient to encode its op-code. Instruction encoding may include setting the number of supported instructions for a slot on the microprocessor core, and the number of registers supported or accessible for the slot.

EScala-CtoRTL instructions may have more than two source operands for specific instructions by adding additional ports to the entirety or part of the register file. The source code 502 may be generated by the user in a text editor or by other means and may be debugged with the debugger 508 in a host environment with convenient operating system support. Once the application behaves as desired on a host platform, its input/output traces may be captured in files and declared acceptable for subsequent steps. The same source code 502 may have now pragmas intended for EScala-CtoRTL flow that may be processed by the preprocessor 512. Information on the source/pragmas may be gathered or and the code at source level may be transformed before being fed into the cross compiler 514 for a given microprocessor.

The cross compiler 514 may be optionally customized for the EScala-CtoRTL framework to facilitate additional steps. The binary output may then be processed by the EScala-CtoRTL framework postprocessor/optimizer software to generate the final program for a given microprocessor configuration. During initial phases of this process, the configuration files may be automatically generated by the optimizer software. This auto-generation of configuration files may be performance/area/power driven based on application run statistics and automated analysis of user provided application instances. Post-processing may allow the user to choose from a variety of compiler vendors and versions as long as the produced ISA is compatible with EScala-CtoRTL ‘s software flow inputs. EScala-CtoRTL may utilize an OpenRISC input base ISA but the invention is not limited to OpenRISC as an input. By providing a high level of fine-grained configurability, EScala-CtoRTL may enable fast time to market for the development of complex blocks. The high level of configurability may allow selecting sufficient resources to achieve the right performance and at the same time removing from the solution the resources that are not required. This may allow efficient (in terms of area and power) implementation of complex blocks in short time spans. C to RTL conversion may be implemented as a fine-grained particularization of the microprocessor core expressed as a human written template with many parameters that may be configured semi-automatically or with user control. The conversion may be implemented in hardware description language.

Fine-grained configurability may be intrinsically more complex than coarse grained configurability. EScala-CtoRTL flow may address this issue by allowing automated configuration of many of the relevant parameters, leaving to the user the option to configure parameters as well. EScala-CtoRTL may require the user to provide a lower number of input parameters to drive the configuration to the desired performance/power/area design point. The EScala-CtoRTL automated configuration flow may be based on an automated analysis of an application or applications of interest and performance statistics/traces taken over runs on a plurality of data sets.

Additionally, a post-processing approach for the software flow may have the following benefits:
Simplified management of tool-chain versioning, by keeping most of the configuration aware passes of the compiler on the post-processing stages of the compiler.
Protection of investment as the process is independent of the tool-chain used.
Software simplicity, as it is not required to start with the port of a full tool-chain to provide a custom microprocessor configuration to an application and related application transformations to fit that microprocessor.
Fast turn-around cycles, as new tool-chains need not be generated for each EScala-CtoRTL configuration because the later/postprocessing portion of the compiler may read at run-time configuration details of the EScala-CtoRTL instance being handled.
The invention may be top down and application driven.

The present invention therefore provides for automating the customization of a highly configurable microprocessor. Further, the present invention allows for high performing programmable solutions and simple software tool-chain management.

EScala-CtoRTL may be used as a micro-processor generator in a C-to-RTL framework to produce RTL (Register Transfer Level description) out of C/C++ sequential untimed descriptions.

EScala-CtoRTL flow is a variation of this flow in which the final configuration produced by EScala-CtoRTL is deprived of its re-programmability with the intent to gain higher efficiency in area and power. This produces code that may be single function and may produce a result that is equivalent to hand-written fixed-function RTL.

With a constantly increasing level of integration in IC (Integrated Circuit)/SoC (System on a chip) devices, parameters like time to market and cost of verification are becoming more relevant than silicon area for many product families.

The present invention may allow unconstrained C/C++ code to be the input for the automated generation of RTL. A C/C++ description may be simpler, more reliable and easier to verify than a corresponding one in RTL. Given that EScala-CtoRTL flow is based on EScala-CtoRTL micro-processor generator flow, it may feature a high degree of flexibility when it comes to the support of high level programming languages like C/C++ and thus there may be no artificial constraints on what type of constructs are supported on the input source code such as complex data structures, recursivity, and dynamic memory allocation.

EScala-CtoRTL may achieve efficiency in the following ways:
a) By using many parameters that feed into an EScala-CtoRTL template based configurable microprocessor. Some of these parameters may be handled by the native HDL (Hardware Description Language) language being generated (e.g. verilog parameters or VHDL (Very High Speed Integrated Circuit Hardware Description Language) generics whereas some others may be intended for a pre-processing step that may take place prior to generating the HDL.
b) By removing the re-programmability of the solution the number of instructions used by the micro-processor may be constrained to a minimum set required to execute a particular fixed application. Additionally the following items may be specialized to a given application:
   Number of registers used.
   Width of each of the registers used (in bits).
   Data ranges supported by specific instructions (e.g. a shifter may need to support only a few specific shift values instead of a general range).
   Instruction encoding.
   Data-path width.
   Limiting which registers can be read/written from a specific slot/data-path of the core.
   Limiting register bypass logic to the paths that are strictly needed.
   Whether other HW blocks are needed or not including:
      Floating point unit, which operators are required, which ones are not, which slots require or do not require, precision.
      Vector unit present or not and which slots can have vector instructions, the characteristics of the vector (number of data items per vector and bit-width of each vector), operations supported.
      Presence/absence of caches, sizes and associativity.
c) Inserting ‘value constraint’ blocks may allow one extra level of area reduction and increase the efficiency of the solution. For the purposes of this application, a “value constraint” block is a combinational block (no clock involved) that takes an N-bit input and generates an N-bit output. The block may also take as parameters a fully enumerated list of valid values on its input side, which can be represented as well as a bit vector. The bit vector may specify which input values are possible on the input and which ones may not be possible (due to constraints ascertained after analyzing the fixed function program being implemented). If the input value falls in one of the possible input values, the block may pass the input value through as-is. If the input value is not one of the specified possible values, the “value constraint” block may ‘stop’ the input value by producing a constant value at its output (0 for instance). The effect of this block (described in more detailed later) may be that the logic that fans-out or is connected to the ‘value constraint’ block may be pruned by standard logic synthesis tools as it may be possible to ascertain that some values are not possible as inputs to the logic downstream of the ‘value constraint’ block. For example, if a barrel shifter gets constrained to only two possible shift values the implementation will become much simpler than a full barrel shifter without having to change the hardware description of the barrel shifter itself. The same may apply to more complex blocks like multipliers, dividers and instruction decoders.

Aspects of the top-level architecture relevant to this invention may be:
The high level of flexibility of the input description (in a high level programming language like C/C++)
The techniques used to customize templated code into fixed function RTL achieving high performance and area efficiency.

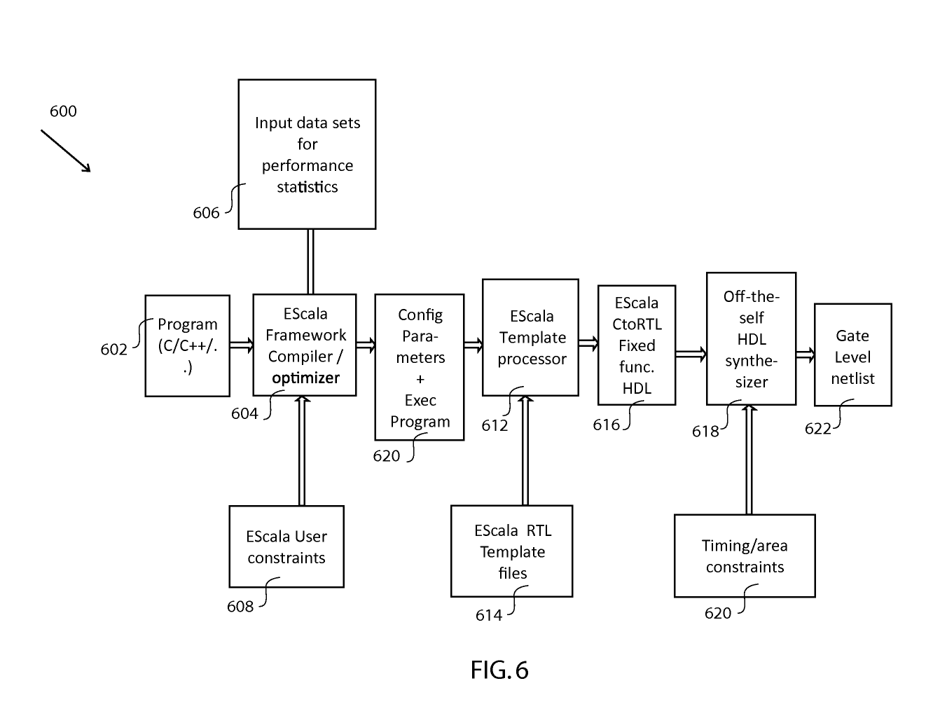

FIG. 6 shows a flowchart 600 of EScala CtoRTL flow. The input source code 602 such as C/C++ may be compiled with a compiler 604 and optimized based on high level user inputs such as high level configuration parameters 608 or user constraints such as the number of memory banks or the total number of data paths/slots the underlying machine may have. This input source code 602 may be entered by the user or generated by EScala-CtoRTL framework user interface tools. This input source code 602 may be combined with input data sets 606 to gather statistics on an input application to be processed by the EScala-CtoRTL framework. The outcome may be a low level executable representation of the program which may become ultimately encoded in the generated HDL as a ROM (Read Only Memory) representing instruction memory and a lengthy set of low level configuration parameters 610 that may be used to personalize EScala-CtoRTL RTL templates using an EScala-CtoRTL template processor 612. The configuration parameters may be applied to EScala-CtoRTL template files 614 to produce fixed function HDL 616 suitable for a RTL to gates standard synthesizer 618 using text processing automated tools. The HDL may then be synthesized to gates (such as a netlist) 622 using standard synthesis tools and timing and/or area constraints 620 and may then be converted to a silicon chip or targeted to a Field Programmable Gate Array (FPGA).

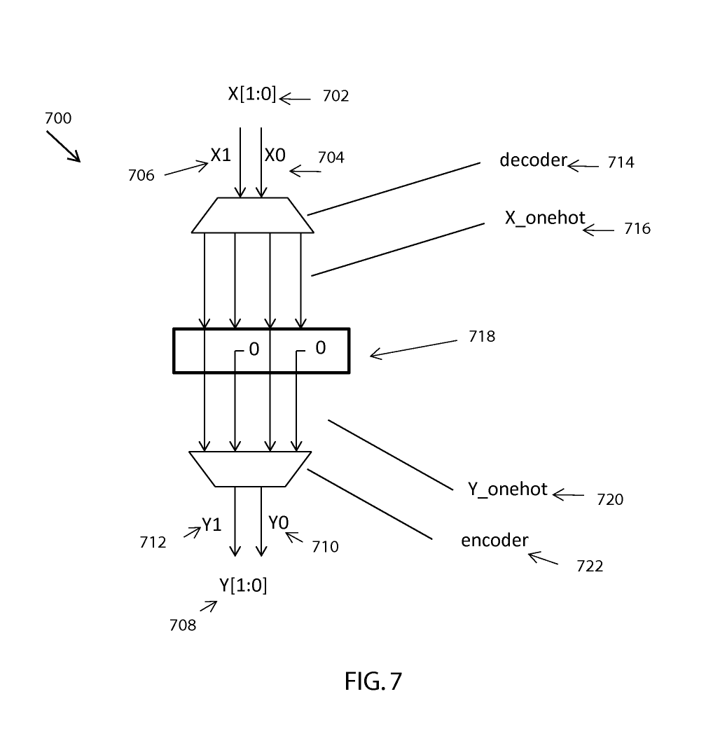

FIG. 7 shows a block diagram 700 showing an example value constraint block. A value constraint block may provide a simple but powerful construct to allow very fine grained specialization of a piece of logic described in an HDL prior to being synthesized by a standard RTL-to-gates synthesizer (e.g. Synopsys design compiler). The block may take a N-bit input vector (X[N-1:0]). 702 shows an example of the case where N=2 but the invention has applicability to any positive N, with bits X0 704 and X1 706. A constant bit vector of possible values may be taken on the input (Allowed_Value[0:(1<<N)-1), where <<represents the left-shift operator, thus Allowed_Value contains 2 to the power of N bits) and produces a N bit output (Y[N-1:0]) 708 with bits Y0 710 and Y1 712 for the example of N=2.

The functionality of a value constraint block may be defined by the following pseudo-code:

ValueContraint (input X, Parameter Allowed_Value) {
if (Allowed_Value[x] == 1) {

Y = X

} else {

Y = constant

}
return Y

}

where ‘constant’ may be, for example, 0 but any other N-bit value may be sufficient.

The functionality of the value constraint block may be as follows: if the input takes an allowed value, the input may pass through unchanged to the output. If the input does not have an allowed value, a constant may be produced on the output FIG. 7 shows a pictorial representation of a value constraint block for 2 bit input/output buses. The value constraint block may have more than two bits. The value limiter may be configured to indicate that only X==1 and X==3 are relevant values (the others may not be expected to happen in the design). This may translate to a configuration for Allowed_Value of the type shown where only Allowed_Value[1] and Allowed_Value[3] have values of 1 (pass-through) whereas all the others are left as 0 (blocked and replaced by constant). A decoder 714 may decompose the value X into a one hot vector (X_onehot) 716. The Value_stopper block 718 may let only some of the values through (the ones where Allowed_Value bit-vector has been configured as 1), and replaced by constants the ones that are not expected to happen on X (configured as Allowed_Value[i]=0 where i is the value not expected to ever happen in X). The output from the Value_stopper block is shown as Y_onehot 720. An encoder 722 reverses this process at the end by producing an output ‘Y’ that matches X for X==1 and X==3 but will have the value of 0 if X ever takes any other value.

The result of this may be that functionality-wise nothing has changed, as X==1 and X==3 may be the only values ever expected, but from an area point of view a logic synthesizer may have enough information to ascertain the X==0 and X==2 are impossible values and it may remove any downstream logic that was instantiated for those combinations. This may allow the HDL to remain the same while allowing the synthesizer to remove unnecessary logic.

In practice ValueConstraint blocks may be populated with assertions to ensure during simulation that the values that are never expected for X actually never show-up during dynamic simulations so there is no risk of having a mismatch between logic synthesis and logic simulation, but this is not strictly required.

The EScala CtoRTL framework may make extensive use of this block/construct as follows: if a portion of the logic can take only a set of specific inputs based on a static analysis of the program targeted for the fixed function hardware, adding a ValueContraint block prior to it will ensure that the HDL-to-gates synthesizer 618 takes advantage to the limited input set to the function being synthesized, thus materializing the area savings associated to that limited input. Multiple ValueConstraint blocks may be paired together.

It should be understood, of course, that the foregoing relates to exemplary embodiments of the invention and that modifications may be made without departing from the spirit and scope of the invention as set forth in the following claims.

What is claimed is:

1. A system for configuring a register transfer level description comprising:
a configurable microprocessor core;
a compiler stored on a development computer system and configured to compile an input programming language;
a register transfer level description template processor stored on the development computer system and configured to translate the programming language into the register transfer level description using a plurality of register transfer level templates; and
a hardware description language synthesizer available on the development computer system,
wherein the system is generated from a human written template with multiple parameters that are configured semi-automatically or with user control,
wherein the system is configured to receive a programming language and output a register transfer level description,
wherein the system utilizes data sets with performance statistics,
wherein the system utilizes template files that include the register transfer level templates, and
wherein the system utilizes timing and area constraints.

2. The system of claim 1, wherein the system includes a value constraint block configured to constrain values input to the microprocessor core on a bus at a bit-level.

3. The system of claim 1, wherein the system is pre-configured for a number of registers used.

4. The system of claim 1, wherein the system is pre-configured for a width (in bits) of each of the registers used.

5. The system of claim 1, wherein the system is preconfigured with respect to data ranges supported for each of a plurality of instructions.

6. The system of claim 1, wherein the system is pre-configured for data path width.

7. The system of claim 1, wherein the system is pre-configured for specifying which registers can be read and written from a specific slot and data path.

8. A system for configuring a register transfer level description comprising:
a one-time configurable, non-reprogrammable microprocessor core;
a compiler stored on a development computer system and configured to compile an input programming language;
a register transfer level description template processor stored on the development computer system and configured to translate the programming language into the register transfer level description using a plurality of register transfer level templates; and
a hardware description language synthesizer available on the development computer system,
wherein the system is configured to receive a programming language and output a register transfer level description,
wherein the system utilizes data sets with performance statistics,
wherein the system utilizes user constraints,
wherein the system utilizes template files that include the register transfer level templates,
wherein the system utilizes timing and area constraints, and
wherein the following are configurable:
presence or absence of an interrupt controller on the microprocessor core;
whether the microprocessor core has a big-endian or little-endian configuration;
width of a data path in the microprocessor core;
whether a plurality of restricted predication instructions are included in a plurality of slots of the microprocessor core;
whether the microprocessor core has a top down and application driven configuration;
whether binary translation post processing into an instruction set architecture from a different processor instruction set architecture is performed;
whether the compiler automatically detects a combination of instructions;
whether user defined extension instructions are provided in different languages as different views of the extension instructions, and are provided as an interface to other instructions;
whether instruction encoding for one of the slots in the microprocessor core includes a set of supported instructions and a number of registers supported for the one of the slots; and
whether a plurality of vector processing units is included;
whether a plurality of floating point units with configurable precision is included and whether data is statistically spread across multiple banks of memory in the microprocessor core

9. The system of claim 8, wherein the system includes a value constraint block configured to constrain values input to or within the microprocessor core on a bus at a bit-level.

10. The system of claim 8, wherein the register transfer description is generated from a human written template with multiple parameters that are configured semi-automatically or with user control.

11. The system of claim 8, wherein the microprocessor core is pre-configured to specify whether a floating point unit is required.

12. The system of claim 11, wherein the microprocessor core is pre-configured to specify which floating point operators are required if a floating point unit is required.

13. The system of claim 12, wherein the microprocessor core is pre-configured to specify which of the plurality of slots in the microprocessor core require a floating point unit.

14. The system of claim 8, wherein the microprocessor core is pre-configured as to which registers can be read or written from a specific slot of the microprocessor core.

15. The system of claim 8, wherein the microprocessor core is pre-configured to limit register bypass logic to application specific paths.

16. A system for configuring register transfer values comprising:
a value constraint block, including
a value limiter configured to determine the relevance of register transfer values on a bus;
a decoder configured to decompose one of the register transfer values on the bus into a vector;
a value stopper configured to allow only relevant ones of the register transfer values on the bus to proceed; and
an encoder configured to re-encode the register transfer values on the bus using the relevant register transfer values on the bus.

17. The system of claim 16, wherein the non-relevant values on the bus are replaced by constant values.

18. The system of claim 16, wherein the value constraint block is paired with a second value constraint block.

19. The system of claim 16, wherein the value constraint block is configured with hardware description language.

20. The system of claim 16, wherein the value constraint block evaluates an input vector of values.
